(19) United States
(12) Patent Application Publication
(10) Pub. No.: US 2010/0078856 A1
(43) Pub. Date: Apr. 1, 2010

(54) Method and Apparatus for Debossing a Silicone Bracelet

(76) Inventor: Carlos Cueto, Miami Lakes, FL (US)

Correspondence Address: JACQUELINE TADROS, P.A., 500 CYPRESS CREEK ROAD WEST, SUITE 350, FORT LAUDERDALE, FL, 33309, US

(21) Appl. No.: 12/571,528

(22) Filed: Oct. 1, 2009

Related U.S. Application Data
(60) Provisional application No. 61/101,686, filed on Oct. 1, 2008.

(51) Int. Cl. B29C 59/02

(52) U.S. Cl. 264/293; 425/470

(57) ABSTRACT

A method and apparatus for debossing a silicone bracelet. The method utilizes an apparatus that includes two opposing press members, with each press member including one or more ridges that form a groove for receiving printing blocks bearing symbols, such as letters of the alphabet, insignia or punctuation to form a customized message for debossing onto a silicone bracelet.

### CROSS-REFERENCE TO RELATED APPLICATIONS

Applicant claims priority from co-pending Provisional Patent Application No. 61/101,686 filed on Oct. 1, 2008 and entitled “Method and Apparatus for Debossing a Silicone Bracelet” under Title 35, United States Code Section 119(e). An entire copy of Provisional Patent Application No. 61/101,686 is incorporated herein by reference.

### BACKGROUND OF THE INVENTION

1. Field Of The Invention

The invention relates generally to the field of embossing, debossing impressing, printing and design and more particularly to a novel method and device for debossing a custom silicone bracelet.

2. Related Prior Art

The process of embossing creates a three dimensional image or design on a surface material. Embossing may be achieved with a combination of heat and pressure. Through the process of impressing or embossing, an image may either be lowered onto a surface or raised out of the surface. Embossing impresses a raised design onto a material.

The process of debossing may be used to embed an image or letters into a silicone band. The process generally involves the application of heat and pressure.

It is known in the art to use a device for impressing food items. For example, U.S. Pat. No. 7,331,776 (to Errera) for a “Food Embossing Stamper Device” discloses a stamping device designed to create images upon a variety of foods for decoration and/or marketing purposes. The device provides both an emboss-only mode, and emboss-and-cut simultaneously mode, in a manner similar to that of a cookie cutter.

U.S. Pat. No. 7,252,491 (to Errera) teaches a “Food Impressing Roller Device” which is a rolling device designed to create images upon a variety of foods for decoration and/or marketing purposes. As the device is hand-rolled along the food, the decorative letters and images create a repeated pattern of impression upon the food.

U.S. Pat. No. 6,990,892 (to Errera) discloses an “Enhanced Food Embossing Stamper Device”. The device is designed to create indented or raised images upon a variety of foods for decoration and/or marketing purposes.

U.S. Pat. No. 5,996,476 (to Schultz) teaches an imprinting press and cooking apparatus for a dough product. The device uses heat and pressure and includes an imprinting station with respective opposed lower press and upper imprinting plates and rotating plate or endless belt conveyors adjacent the imprinting station. Heat sources are disposed adjacent the imprinting station and the conveyors for preheating the dough product for release from the printing station and for cooking the dough product respectively.

U.S. Pat. No. 5,305,538 (to Kanzelberger) discusses a “Plastic Plate with Graphics”. The device is a do-it-yourself kit enabling an end user to make his or her own graphics on the back of a transparent tape. The tape has a pressure sensitive adhesive which is pressed over a textured surface that enables air to escape at the interface between the adhesive and the plate.

U.S. Pat. No. 4,747,991 (to Bishop) for a “Method for Debossing and Selectively Aperturing a Resilient Plastic Web” teaches a method for imparting a selectively apertured three-dimensional pattern to a heated plastic material.

U.S. Pat. No. 4,656,927 (to Mosby et al.) discusses a “Device for Making Designs on Toast”. The device disclosed is for producing designs on a slice of bread during toasting of the bread and comprises a bread holding member removably received within the toast well of an electric toaster.

U.S. Publication No. 2007/0205124A1 (to Dwyre) teaches a “Personalized Presentation Instrument” and discloses a kit for making a personalized presentation instrument including a presentation instrument having a markable region and an information storage medium configured to store a unique identifier, a marking medium suitable for creating a mark on the markable region of the presentation instrument and a package holding the presentation instrument and the marking medium.

The foregoing inventions disclose methods and devices for, embossing, debossing and the like. However, the foregoing inventions are somewhat involved and intricate for use by an individual.

Thus, there is a need for an improved and cost effective method and apparatus for embossing or debossing which is simple can be used by an individual to emboss or deboss a silicone bracelet.

### BRIEF SUMMARY OF THE INVENTION

The general purpose of the present invention, which will be described subsequently in greater detail, is to provide a novel method and device for embossing or debossing a silicone bracelet.

The apparatus of the present invention includes upper and lower block presses. The block presses are provided with one or more ridges. The ridges of the lower press are adapted to receive letters of the alphabet, numbers or punctuation. Letters may be placed within the ridges to create a mirror image of a customizable message, such as “GO PENGUINS” and the like. The ridges of the upper press are complimentarily aligned to the ridges of the lower press.

A quantity of water, sufficient to completely submerge a silicone bracelet is then heated to a boil. The boiling water is removed from heat and the silicone bracelet is placed in the water for a period of twelve seconds.

The bracelet is removed from the water using a pair of forceps or tongs and placed over the customized message of the lower wood press. Care should be taken to center the bracelet over the message. The upper wood press is then firmly placed over the lower wood press such that the ridges of the lower press and the ridges of the upper press are complimentarily aligned. Downward pressure is exerted on the upper press for a period of ten minutes.

The bracelet is removed from the lower wood press and submerged in ice cold water for a period of two to four minutes to set the customizable message.

An object of the apparatus and method of the present invention is to provide an individual with a simple at home kit to create customized silicone bracelets.

An advantage of the apparatus and method of the present invention is that it allows a user to create a customized silicone bracelet at a reduced cost.

Another advantage of the apparatus and method of the present invention is that it is simple, quick and easy to use.

There has thus been outlined, rather broadly, the more important features of the invention in order that the detailed description thereof may be better understood, and in order that the present contribution to the art may be better appreciated. Other features and advantages of the present invention will become apparent from the following more detailed description, taken in conjunction with the Brief Description of the Drawings and accompanying drawings, which illustrate, by way of example, the principles of the invention, as well as the Detailed Description of the Invention and Claims appended herewith.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates a side perspective view of the upper and lower wood press with letters of the alphabet arranged on the lower press to create a customized message;

FIG. 2 is a side perspective view of the upper and lower press of the present invention;

FIG. 3 illustrates a silicone bracelet before and after the debossing method of the present invention;

FIG. 4 illustrates a silicone bracelet placed over a customized message on the lower press;

FIG. 5 illustrates an operational view of the apparatus of the present invention;

FIG. 6 illustrates an operational view of an alternative embodiment of the apparatus of the present invention; and

FIG. 7 is a block diagram of the method, as illustrated in the present invention for debossing a customized image on a silicone bracelet.

FIG. 8 illustrates an alternative embodiment of the apparatus of the present invention.

For purposes of clarity and brevity, like elements and components will bear the same designations and numbering throughout the Figures.

### DETAILED DESCRIPTION OF THE INVENTION

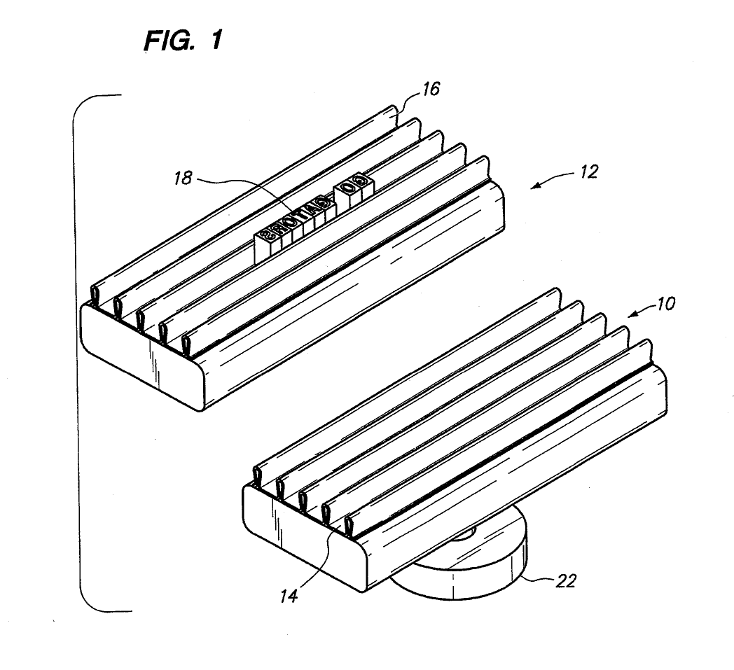

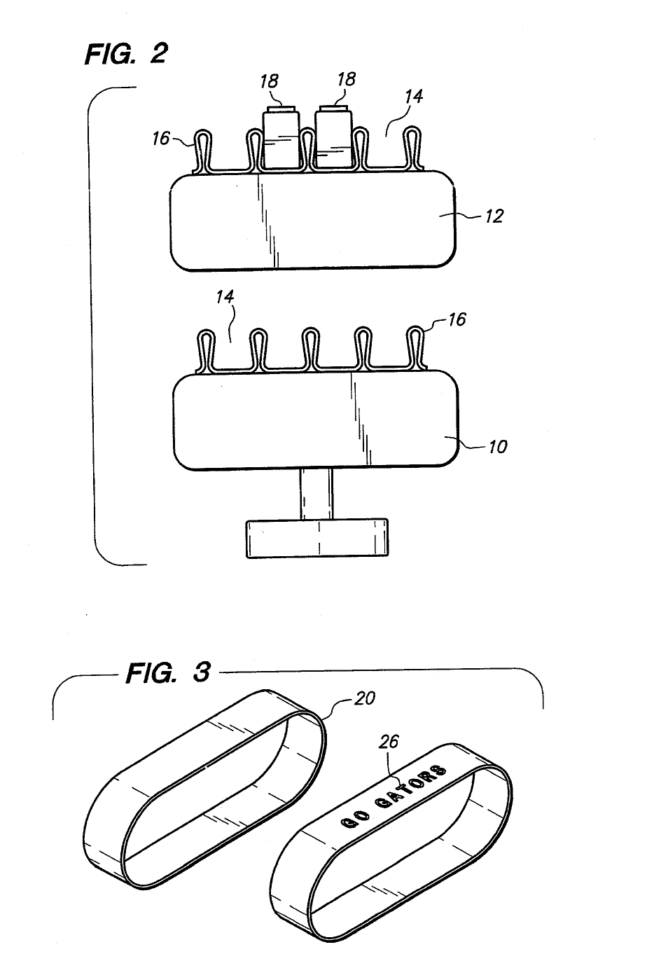

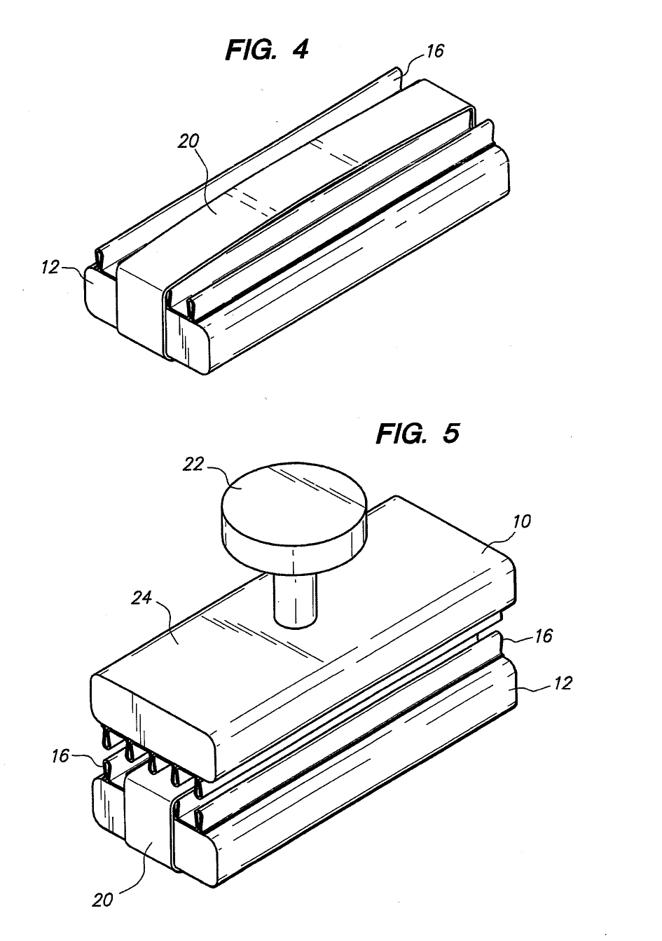

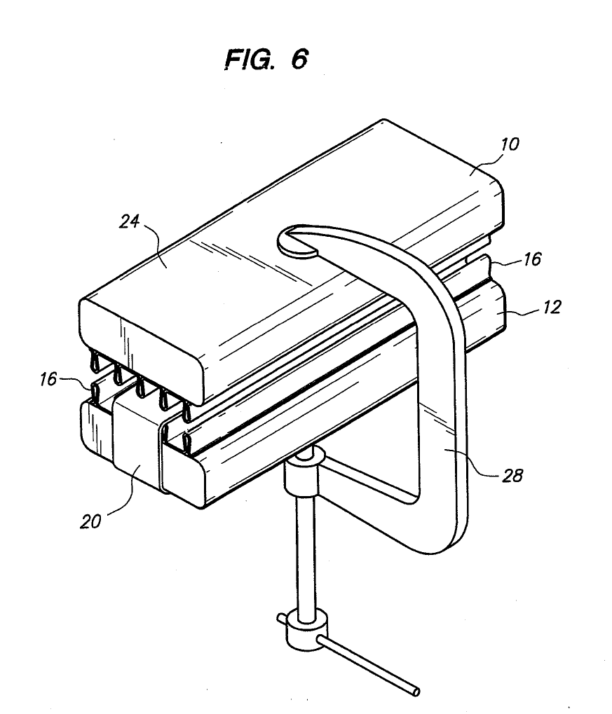

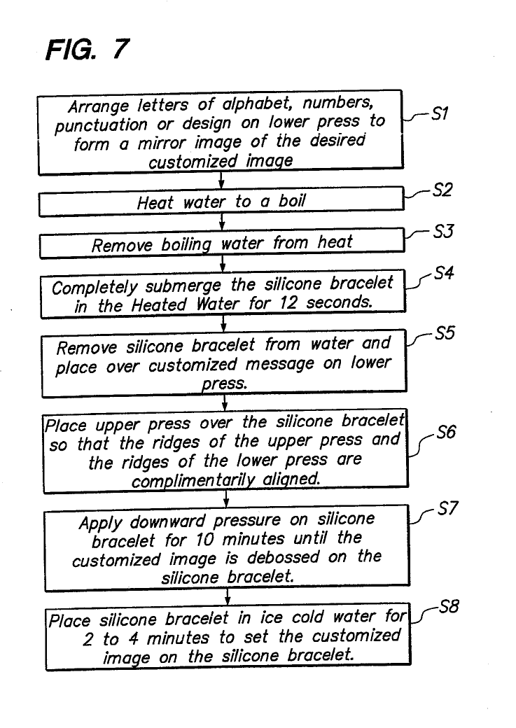

The present invention is described with references to the enclosed Figures wherein the same numbers are utilized where applicable. Referring now to FIGS. 1 to 8, in one embodiment, the present invention provides an upper 10 and lower 12 press. A knob 22 is affixed, on an outer face 24 of the upper press 10, as known by one reasonably skilled in the art.

The upper 10 and lower 12 press each include one or more longitudinal canals 14. Ridges 16 of the upper press 10 and lower press 12 along a vertical axis define a longitudinal axis along the canals 14 for receiving printing blocks 18 bearing letters of the alphabet, symbols or punctuation. One or more printing blocks 18 are arranged within the canals 14 to form a mirror image of the customized message or design 26.

The ridges 16 of the lower press 12 are complimentarily aligned to engage the ridges 16 of the upper press 10.

Referring now to FIGS. 1 to 8, according to the method of the present invention, a silicone bracelet 20 is completely submerged in boiling water, the water having been removed from its heat source prior to submersion of the silicone bracelet 20. The bracelet 20 remains in the water for a period of generally ten to twelve seconds and is removed using a pair of tongs or forceps (not shown).

The heated bracelet 20 is immediately placed and centered over a customized image that has been arranged on the lower press 12. The upper press 10 is placed over the centered bracelet 20. A vertical downward pressure is manually exerted using the knob 22 affixed, on the upper press 10 for a period of ten minutes to effect the transfer of the customized message from the lower press 12 to the silicone bracelet 20.

In an alternative embodiment, a C clamp 28 may be used to exert pressure on the silicone bracelet to transfer the customized message, as is shown in FIG. 6. As will be appreciated by those reasonably skilled in the art variations of the C clamp may be used to the pressure required to transfer the customized message on to the silicone bracelet.

The bracelet 20 is submerged in ice cold water for a period of two to four minutes to set the customized message or image that has been debossed on the bracelet 20.

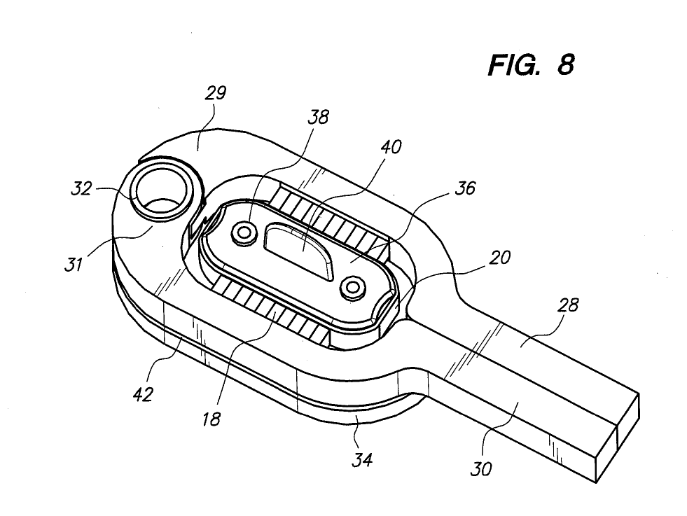

In an alternative embodiment, as illustrated in FIG. 8, an apparatus for debossing a silicone bracelet includes a first handle 28 with an upper member having a convex end 29 and a second handle 30 with an upper member having a concave end 31, the concave end 31 having a bore for receiving a cylindrical collar. The convex end 29 and concave end 31 are matingly interconnected, as will be appreciated by those skilled in the art, at a common point of juncture 32 for rotatable attachment. A base member 34 is fixedly attached to the concave end 31 of the upper member of the second handle 30 and the convex end 29 of the upper member of the first handle 28 at the common point of juncture 32.

A gap 42 between the base 34 and first handle 28 and second handle 30 allows for rotatable movement of the first and second handle 28, 30, about the common point of juncture 32. The base 34 includes a center platform 36 having a generally oval shape. The center platform 36 is fixedly attached to the base 34 using at least one bolt 38. In an alternative embodiment, the center platform 36 includes a flange 40 for grasping the apparatus of the present invention.

Printing blocks 18 are positioned along the first handle 28 as shown in FIG. 8. In an alternative embodiment, printing blocks 18 are positioned along the second handle as shown in FIG. 8. The silicone bracelet 20 is placed in boiling water and removed from the water after a period of time, the time measured as a period of generally twelve seconds. The heated silicone bracelet 20 is placed around the center platform 36 for embossing. The first handle 28 and second handle 30 are pressed together to force the printing blocks 18 to exert pressure on the silicone bracelet 20 for transposing a mirror image of a symbol on the printing block 18 onto the silicone bracelet 20.

While there has been shown and described the preferred embodiments of the instant invention it is to be appreciated that the invention may be embodied otherwise than is herein specifically shown and described and that, within said embodiments, certain changes may be made in the form, dimensions and arrangement of the parts without departing from the underlying ideas or principles of this invention as set forth herein.

What is claimed is:

1. An apparatus for debossing a silicone bracelet, the apparatus comprising an upper press and a lower press, the upper press further comprising a knob affixed to an outer face of the upper press and wherein the upper and lower presses each include one or more ridges, the ridges forming a groove for receiving one or more printing blocks bearing symbols, wherein the symbols include letters of the alphabet, insignia or punctuation, the letters, insignia or punctuation forming a customized message for debossing onto the silicone bracelet.

2. A method of using a debossing system for debossing a silicone bracelet, the method comprising the steps of:
(a) arranging a mirror image of at least one symbol to form a customized image on a lower press, wherein the lower press includes ridges along a groove for receiving a printing block;
(b) applying a heat source to heat water to its boiling point;
(c) removing the heated water from the heat source;
(d) completely submerging a silicone bracelet in the water for a period of time;
(e) removing the silicone bracelet of step 2(d) from the water and placing over the lower press along the vertical axis of the lower press and over the customized image;
(f) placing an upper press, wherein the upper press includes ridges forming groove and wherein the ridges of the upper press are complimentarily aligned along a vertical axis with the ridges of the lower press over the silicone bracelet of step 2(e);
(g) applying a downward force on the silicone bracelet for a period of time for debossing the customized image onto the silicone bracelet of step 2(f); and
(h) submerging the silicone bracelet of step 2(g) in ice cold water for a period of time to set the customized image on the silicone bracelet.

3. The method of claim 2, wherein the period of time of step 2(d) is generally twelve seconds.

4. The method of claim 2, wherein the period of time of step 2(g) is generally ten minutes.

5. The method of claim 2, wherein the period of time of step 2(h) is generally in the range of two to four minutes.

6. The method of claim 2, wherein the symbol includes letters of the alphabet, insignia or punctuation to form a customized message for debossing onto the silicone bracelet.

7. An apparatus for debossing a silicone bracelet, the apparatus comprising a first handle comprising an upper member having a convex end, a second handle comprising an upper member having a concave end, wherein the concave end is matingly connected to the convex end of the upper member of the first handle at a common point of juncture for rotatable attachment; a base having a center platform; means for fixedly attaching the center platform to the base; and means for fixedly attaching the base to the concave end of the upper member of the second handle and the convex end of the upper member of the first handle at the common point of juncture.

8. The apparatus of claim 7, wherein the platform is generally an oval shape.

9. The apparatus of claim 7, wherein the means for fixedly attaching the center platform to the base comprises at least one bolt.

10. The apparatus of claim 7, wherein the platform includes a flange.

11. The apparatus of claim 7, wherein the concave end of the upper member of the second handle includes a bore for receiving a cylindrical collar.
